(19) United States
(12) Patent Application Publication
(10) Pub. No.: US 2026/0086825 A1
(43) Pub. Date: Mar. 26, 2026

(54) METHOD, APPARATUS, DEVICE, STORAGE MEDIUM AND PROGRAM PRODUCT FOR REQUEST PROCESSING

(71) Applicant: Beijing Zitiao Network Technology Co., Ltd., Beijing (CN)

(72) Inventor: Longteng PENG, Beijing (CN)

(21) Appl. No.: 18/987,858

(22) Filed: Dec. 19, 2024

(30) Foreign Application Priority Data
Sep. 20, 2024 (CN) 202411320799.2

(51) Int. Cl. G06F 9/445; G06F 9/54

(52) U.S. Cl. CPC G06F 9/44526; G06F 9/546

(57) ABSTRACT

The disclosure provides a method, apparatus, device, storage medium and program product for request processing. The method includes: in response to acquiring a user request of a target user for a digital assistant, determining a first set of plug-ins from a plurality of candidate plug-ins for the digital assistant based on status information of the plurality of candidate plug-ins; determining at least one target plug-in from the first set of plug-ins based at least on description information of each plug-in in the first set of plug-ins and the user request by using a first machine learning model, the description information of each plug-in indicating a function of the corresponding plug-in; and determining a reply of the digital assistant to the user request by invoking the at least one target plug-in to at least partially process the user request.

### CROSS-REFERENCE

The present application claims priority to Chinese Patent Application No. 202411320799.2, filed on Sep. 20, 2024, and entitled “METHOD, APPARATUS, DEVICE, STORAGE MEDIUM AND PROGRAM PRODUCT FOR REQUEST PROCESSING”, the entirety of which is incorporated herein by reference.

### TECHNICAL FIELD

Example embodiments of the present disclosure generally relate to the field of computers, and in particular, to a method, an apparatus, an electronic device, a computer-readable storage medium, and a computer program product for request processing.

### BACKGROUND

With the development of information technologies, various client devices may provide users with various services in terms of work and life. For example, an application providing a service may be deployed in the client device. The client device or application may provide functions of a digital assistant type to users to assist their use of the client device or application.

### SUMMARY

In a first aspect of the present disclosure, a method for request processing is provided. The method includes the following steps: in response to acquiring a user request of a target user for a digital assistant, determining a first set of plug-ins from a plurality of candidate plug-ins for the digital assistant based on status information of the plurality of candidate plug-ins, the first set of plug-ins being in an enabled status for the user request; determining at least one target plug-in from the first set of plug-ins based at least on description information of each plug-in in the first set of plug-ins and the user request by using a first machine learning model, the description information of each plug-in indicating a function of the corresponding plug-in; and determining a reply of the digital assistant to the user request by invoking the at least one target plug-in to at least partially process the user request.

In a second aspect of the present disclosure, an apparatus for request processing is provided. The device includes a first plug-in determining module configured to determine, in response to acquiring a user request of a target user for a digital assistant, a first set of plug-ins from a plurality of candidate plug-ins for the digital assistant based on status information of the plurality of candidate plug-ins, the first set of plug-ins being in an enabled status for the user request; a target plug-in determining module configured to determine at least one target plug-in from the first set of plug-ins based at least on description information of each plug-in in the first set of plug-ins and the user request by using a first machine learning model, the description information of each plug-in indicating a function of the corresponding plug-in; and a reply determining module configured to determine a reply of the digital assistant to the user request by invoking the at least one target plug-in to at least partially process the user request.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method according to the first aspect of the present disclosure.

In a fourth aspect of the present disclosure, there is provided a computer-readable storage medium having stored thereon a computer program which, when executed by a processor, causes the processor to perform the method according to the first aspect of the present disclosure.

In a fifth aspect of the present disclosure, a computer program product is provided. The computer program product is tangibly stored in a computer storage medium and includes computer-executable instructions that, when executed by a device, cause the device to perform the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent in conjunction with the accompanying drawings and with reference to the following detailed description. In the drawings, the same or similar reference numbers refer to the same or similar elements, where:

FIG. 1 illustrates a schematic diagram of an example environment in which embodiments of the present disclosure can be implemented;

FIG. 2 illustrates a flowchart of a signaling flow for request processing according to some embodiments of the present disclosure;

FIG. 3 illustrates an example of a correspondence among a terminal device, a user, and an application;

FIG. 4 illustrates a flowchart of a signaling flow for creating and updating a plug-in according to some embodiments of the present disclosure;

FIG. 5 illustrates a flowchart of a method for request processing according to some embodiments of the present disclosure;

FIG. 6 illustrates an example structural block diagram of an apparatus for request processing according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

Herein, unless explicitly stated otherwise, “performing a step-in response to A” does not mean that the step is performed immediately after “A”, but one or more intermediate steps may be included.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, usage ranges, usage scenarios, and the like of the personal information involved in this disclosure in an appropriate manner and the user's authorization shall be obtained, in accordance with relevant laws and regulations.

For example, in response to receiving an active request from a user, prompt information is sent to the user to explicitly prompt the related user that an operation requested by the user will require obtaining and use of information of the user. Thus, the user can autonomously select, according to the prompt information, whether to provide information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide information to the electronic device.

It can be understood that the above notification and user authorization process are only illustrative, which do not limit the implementation of this disclosure. Other methods that meet relevant laws and regulations can also be applied to the implementation of this disclosure.

As used in this specification, the term “model” may learn association between corresponding input and output from training data, so that after the training is complete, corresponding output may be generated for given input. The generation of the model may be based on a machine learning technology. Deep learning is a machine learning algorithm that processes input and provides corresponding output by using a multi-tiered processing unit. A neural network model is one example of a model based on deep learning. In this specification, “model” may also be referred to as “machine learning model,” “learning model,” “machine learning network,” or “learning network”, which may be used interchangeably in this specification.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may roughly include three phases, namely a training phase, a testing phase, and an application phase (also referred to as an inference phase). In the training phase, a given model may be trained by using a large amount of training data, constantly and iteratively updating parameter values until the model obtains consistent reasoning that meets expected goals from the training data. By training, the model may be considered as being able to learn an association between input and output from training data (also referred to as mappings of input to output). A parameter value of the trained model is determined. In the testing stage, a test input is applied to the trained model, so as to test whether the model can provide a correct output, thereby determining the performance of the model. Sometimes, the testing phase may be fused in the training phase. In the application or inference phase, the trained model may be configured to process actual model input based on the trained parameter value to determine corresponding model output.

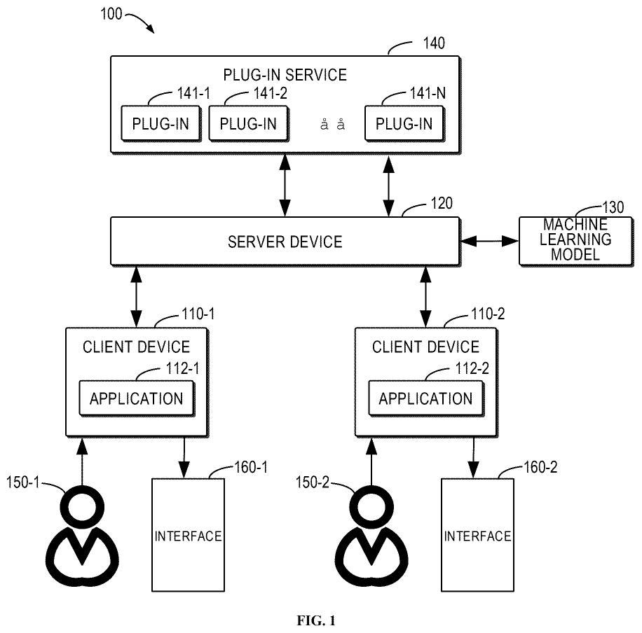

FIG. 1 illustrates a schematic diagram of an example environment 100 in which embodiments of the present disclosure can be implemented. The example environment 100 may relate to at least one terminal device 110 (for example, the terminal device 110-1 and the terminal device 110-2), and each terminal device 110 is installed with an application (for example, an application 112-1 is installed in the terminal device 110-1, and an application 112-2 is installed in the terminal device 110-2). For ease of description, one or more terminal devices may be collectively referred to as the terminal device 110, and one or more applications are collectively referred to as the application 112. It may be understood that although FIG. 1 only illustrates two terminal devices 110, in practice, any number of terminal devices may be involved.

In some embodiments, the application 112 may be downloaded, installed on the terminal device 110. In some embodiments, the application 112 may also be accessed in other manners, such as be accessed by a web page. The user 150 may interact with the application 112 via the terminal device 110 and/or an attachment device of the terminal device 110. For example, a user 150-1 may interact with the application 112-1 via the terminal device 110-1, and a user 150-2 may interact with the application 112-2 via the terminal device 110-2. Similarly, one or more users may be collectively referred to as the user 150 for ease of description.

In an embodiment of the present disclosure, the application 112 may be any suitable application having a task processing function, and may include, but is not limited to, one or more of the following: a chat application component (also referred to as an instant messaging application component), a browser application component, a planning application component, a document application component, an audio and video conference application component, a mail application component, a task application component, a calendar application component, an objective and key result (OKR) application component, and the like. It may be understood that although only a single application 112 is illustrated in each terminal device 110 in FIG. 1, in practice, each terminal device 110 may be installed with a plurality of applications 112.

In some embodiments, the application 112 may include a multifunctional collaboration platform, for example, an office collaboration platform (also referred to as an office suite), which can provide integration of multiple types of business components, so that people can conveniently perform activities such as work and communication. In the multifunctional collaboration platform, people can start different service components as needed, to complete corresponding information processing, sharing, communication and the like.

In environment 100, in response to the application 112 being started, the terminal device 110 may present interface 160 of the application 112. The interface 160 may include, for example, an interaction interface between the user 150 and the application 112. In some embodiments, an interaction window of the user 150 with a digital assistant may be presented in interface 160 (e.g., the application 112 is a digital assistant itself or a function integrated with a digital assistant). In the interaction window, the user 150 can have a dialog with the digital assistant by inputting a natural language, a picture, an audio file, a video file, a web page file, etc., to instruct the digital assistant to assist in completing various tasks.

A digital assistant is an intelligent assistant of a user, which has an intelligent dialog capability and an information processing capability. The digital assistant may be considered a separate application 112, or may be integrated in the application 112. In an embodiment of the present disclosure, the digital assistant is configured to interact with the user 150 to assist the user 150 in using the terminal device or the application. In some embodiments, a plurality of interaction modes of the user 150 with the digital assistant may be provided, and a switching between the plurality of interaction modes may be performed flexibly. In the event that a certain interaction mode is triggered, a corresponding interaction area is presented to facilitate interaction of the user 150 with the digital assistant. The interaction manners of the user 150 with the digital assistant in different interaction modes are different, which can flexibly adapt to interaction requirements in different application scenarios.

The interaction window of the digital assistant with the user 150 may include a conversation window, such as a conversation window in an instant messaging application or in an instant messaging module of a particular application. In the conversation window, the interaction between the digital assistant and the user 150 may be presented in the form of a conversation message. Alternatively, or additionally, the interaction window of the digital assistant with the user 150 may further include other types of windows, such as a window of a floating window mode, where the user 150 may trigger the digital assistant to perform a corresponding operation by inputting an instruction, selecting a shortcut instruction, or the like.

In some embodiments, the digital assistant may support an interaction mode of the conversation window, also referred to as conversation mode. In this interaction mode, a conversation window of the user 150 with the digital assistant is presented, and in the conversation window, the user 150 interacts with the digital assistant through conversation messages. In the conversation mode, the digital assistant may execute a task according to a conversation message in the conversation window. In the interaction window, the user 150 inputs an interaction message, and the digital assistant provides a reply message in response to the user input. The conversation window of a digital assistant with the digital assistant may be opened by selecting the digital assistant. The conversation window may include interface elements for information interaction, such as input boxes, message lists, message bubbles, and the like.

The digital assistant is provided to assist the user 150 in various task processing requirements in different applications and scenarios. The digital assistant typically has intelligent dialogue and task processing capabilities. During interaction with the digital assistant, the user 150 inputs user input (e.g., text, voice, image, video, or other modalities of dialogue content), and the digital assistant provides a corresponding reply in response to the user input. In general, the digital assistant can support the user 150 entering questions in a natural language manner and performing the task and providing a reply based on understanding of natural language input and logical reasoning capabilities.

In some embodiments, the digital assistant supports the use of plug-ins. At the creation phase of the digital assistant, the user who creates the digital assistant may associate one or more plug-ins with the digital assistant. In the application phase of the digital assistant, the user request for the digital assistant may be processed by invoking a particular plug-in in the associated one or more plug-ins. Such plug-ins include, but are not limited to, one or more of a search plug-in, a contact plug-in, a message plug-in, a document plug-in, a table plug-in, a mail plug-in, a calendar plug-in, a schedule plug-in, a task plug-in, and the like.

Each plug-in can provide one or more functions of the application. In general, a plug-in may be understood as a collection of functions, while a “tool” in a plug-in may be understood as a unit function or an element function in a plug-in. With a plurality of tools, the plug-in can ultimately be used to process a type of tasks desired by the user. For example, a plug-in for processing a document may include a document creation tool for creating a new document; a search tool for performing a search in the document; a formula generation tool for generating and inserting a formula in the document, and so on.

In the embodiment of the present disclosure, the plug-in service 140 provides an environment for the user 150 to create, publish, save, and apply the plug-in 141. The user who creates and publishes the plug-in and the user who applies the plug-in may be the same user or different users. For example, the user 150-1, as a plugin creator, may create one or more plugins. The user 150-2, as a plug-in applicator, may apply one or more plug-ins associated with the digital assistant. The plug-in service 140 may be deployed with, for example, a database by which the created plug-in 141 is saved. For example, a plug-in 141-1, a plug-in 141-2, . . . , a plug-in 141-N, etc., may be saved at the plug-in service 140. It should be noted that, the plug-in service 140 may be deployed at the server device 120, or may be deployed on another device. In the embodiments of the present disclosure, for convenience of description, the plug-in service 140 being deployed at the server-side device 120 is illustrated by way of example.

The terminal device 110 may be deployed with a client application or platform such as a plug-in creation platform and/or a plug-in application platform, and the client application or platform may support interaction between the user 150 and the plug-in creation platform and/or the plug-in application platform. In some embodiments, the server device 120 may be deployed with a plug-in creation platform and/or a plug-in application platform, and the server device 120 may provide support for a client program deployed in the terminal device 110.

In some embodiments, the plug-in creation platform may interact with the plug-in service 140 to enable creation of the plug-in 141. The plug-in creation platform may provide the set of tools required for creation of the plug-in 141. The plug-in creation platform may support visual development of the plug-in 141. The plug-in creation platform may support any suitable platform for the user development interface. In some embodiments, a plug-in application platform may interact with plug-in service 140 to enable calls to the plug-in 141. After the plug-in 141 is created, the user 150 may input a conversation message in the conversation window of the digital assistant, the digital assistant may request the plug-in service 140 to assist in invoking the plug-in 141 based on the plug-in definition of the plug-in 141, obtain the feedback information by using the plug-in 141, determine a reply message based on the feedback information, and present the reply message to the user in the conversation window.

In some embodiments, a communication connection is established between the terminal device 110 and the server device 120. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the terminal device 110 and the server device 120 may implement signaling interaction through a communication connection between the terminal device 110 and the server device 120, to supply services to the application 112 and/or the digital assistant.

As shown in FIG. 1, the server device 120 may invoke the machine learning model 130. It may be understood that the machine learning model 130 may include one or more machine learning models, that is, the server device 120 may invoke one or more machine learning models, and the one or more machine learning models may be collectively referred to as the machine learning model 130. It should be noted that, if the machine learning model 130 includes a plurality of machine learning models, the plurality of machine learning models may have different uses and functions, which is not limited in the present disclosure.

The machine learning model 130 may be deployed on the server device 120, or may be deployed on other devices. The machine learning model 130 may be based on any suitable model structure including, but not limited to, a Transformer model, a convolutional neural network (CNN), a recurrent neural network (RNN), a deep neural network (DNN), or the like. In some embodiments, the machine learning model 130 may be based on a language model (LM). The language model may have question-and-answer capability by learning from a large amount of corpus. The machine learning model 130 may also be based on other suitable models.

The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.).

The server device 120 may be a separate physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, or the like.

It should be understood that the structures and functions of the various elements in the environment 100 are described for purposes of example only, which do not imply any limitation to the scope of the present disclosure.

As mentioned above, with the development of information technologies, various client devices may provide various services to people in terms of work and life. For example, an application providing a service may be deployed in the client device. The client device or application may provide a digital assistant type function to the user to assist the user in using the client device or application.

To improve the functional diversity of digital assistants, some developers configure digital assistants to support the use of plug-ins, each of the plug-ins is capable of providing one or more functions. The digital assistant may invoke a corresponding plug-in according to a demand of the user to provide service for the user.

In the related art, it is generally necessary to determine a to-be-called target plug-in from a plurality of plug-ins by means of a machine learning model. If the number of plug-ins included in the plurality of plug-ins is large, a larger computation cost is required by the machine learning model to determine the target plug-in, thus the efficiency is worse. This may affect the efficiency and accuracy of invoking the plug-in.

In view of this, according to an embodiment of the present disclosure, an improved solution for request processing is provided. According to the solution of the embodiment of the present disclosure, in response to acquiring a user request of a target user for a digital assistant, a first set of plug-ins are determined from a plurality of candidate plug-ins based on status information of the plurality of candidate plug-ins for the digital assistant, and the first set of plug-ins are in an enabled status for the user request. At least one target plug-in is determined from the first set of plug-ins based at least on description information of each plug-in in the first set of plug-ins and the user request by using the first machine learning model, and the description information of each plug-in indicates a function of the corresponding plug-in. A reply of the digital assistant to the user request is determined by invoking the at least one target plug-in to at least partially process the user request.

In this way, at least one round of screening may be performed on the plurality of candidate plug-ins before the target plug-in is determined, and the target plug-in is determined from the set of plug-ins obtained through the screening. By determining the target plug-in for processing the user request from a small number of screened plug-ins, the calculation overhead required for selecting the target plug-in in the request processing can be reduced, and the efficiency and accuracy of determining the plug-in are improved. Further, in some embodiments, flexible enabling and disabling of plug-ins available to the digital assistant may also be provided. In this case, when the user request for the digital assistant is processed, the plug-ins in the enabled status may be screened and obtained, and the plug-in for processing the current user request is further obtained by screening the plug-ins in the enabled status.

Some example embodiments of the present disclosure will be described below with continued reference to the accompanying drawings.

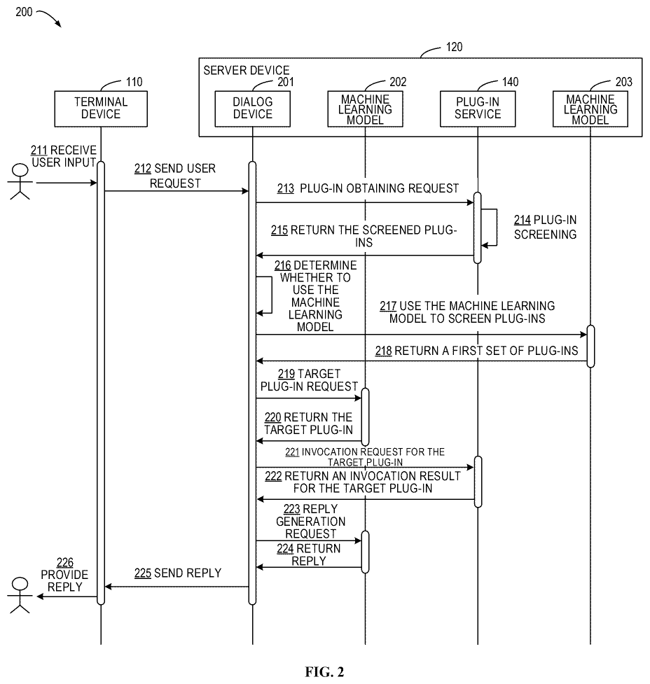

FIG. 2 shows a flowchart of a signaling flow 200 for request processing according to some embodiments of the present disclosure. For ease of discussion, the signaling flow 200 will be described with reference to the environment 100 of FIG. 1.

The signaling flow 200 relates to the terminal device 110 and the server device 120, and the server device 120 includes a dialog service 201, a machine learning model 202, a plug-in service 140, and a machine learning model 203. The machine learning model 202 and the machine learning model 203 may be machine learning models included in the machine learning model 130. The machine learning model 202 and the machine learning model 203 may be configured to perform different tasks. In some embodiments, the machine learning model 202 may be based on a language model (LM). In some embodiments, the machine learning model 202 may be referred to as a first machine learning model, and the machine learning model 203 may be referred to as a second machine learning model.

In some embodiments, a model size of the machine learning model 203 may be smaller than a model size of the machine learning model 202. The model size of each machine learning model is associated with a parameter scale, model structure complexity, etc. of the machine learning model. Generally, the larger the parameter scale or the more complex the structure of the machine learning model, the larger the model size of the machine learning model. A machine learning model with a larger model size requires a larger resource overhead, and the resource overhead includes, but are not limited to, computing resources, memory resources, and the like.

It may be understood that, although the signaling flow 200 in FIG. 2 only relates to the two machine learning models: the machine learning model 202 and the machine learning model 203, more machine learning models may actually be involved in the operations of the signaling flow, which is not limited in the present disclosure, and the example description is provided only by taking two machine learning models being involved as an example.

In some embodiments, the terminal device 110 may present an interaction interface (e.g., the interface 160) of a target user (e.g., the user 150) with a digital assistant (e.g., a digital assistant). For example, the interaction interface may include an input control such as an input box. In the interaction between the target user and the digital assistant, the terminal device 110 may receive (211), via the interaction interface, the user input entered by the target user through the input box. If the interaction interface includes a conversation window, the user input may be presented in the interaction interface in the form of a conversation message from the target user.

The user input may be any suitable type of input including but not limited to a text type, an image/video type, and a voice type, which is not limited in the present disclosure. For example, the terminal device may determine the user request of the target user based on the received user input. In some embodiments, if the user input is an input of a non-text type (for example, a voice type), the terminal device 110 may convert the user input into a text type and determine a user request based on the converted user input.

In some embodiments, the user request may further include identification information. The terminal device 110 may add identification information to the user input of the target user to obtain the user request of the target user. The user request may be initiated via the target terminal device (e.g., the terminal device 110), and may be initiated specifically via a target application in the target terminal device. The identification information in the user request may include one or more of a device identifier of the target terminal device corresponding to the user request (represented as device_id, which may be a device model, a device name, a device ID, and the like), a user identifier of the target user (represented as user_id, which may be a user name of the target user, an ID of the target user, and the like), an application identifier of the target application corresponding to the user request (represented as app_id, which may be an application name, an application ID, an application type, and the like), and the like. It may be understood that device identifiers of different terminal devices are different, user identifiers of different users are different, and application identifiers of different applications are different.

It should be noted that, there may be a one-to-many relationship between the terminal devices, the users, and the applications. For example, each terminal device may correspond to a plurality of users (that is, the plurality of users may use a same terminal device), and each terminal device may be installed with a plurality of applications associated with a digital assistant. Each user may correspond to a plurality of terminal devices (that is, the same user may use the plurality of terminal devices), and each user may correspond to a plurality of applications (that is, the same user may interact with the plurality of applications separately). Each application may correspond to a plurality of users (that is, the plurality of users may interact with the same application), and a plurality of terminal devices may be installed with the same application. Each user may log into the application/log into the terminal device by using the account corresponding to the user, to interact with the application/use the terminal device.

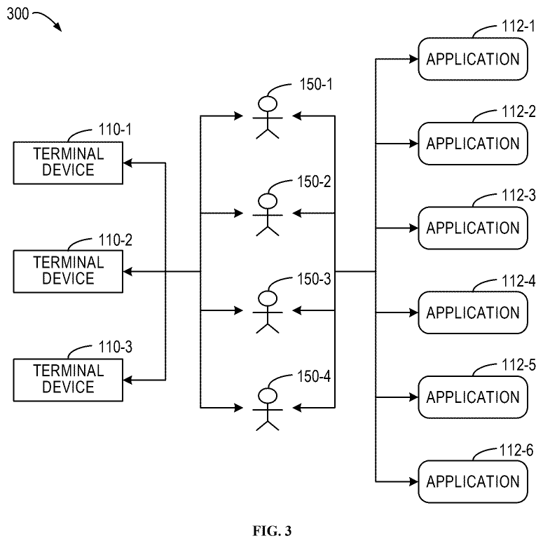

Referring to FIG. 3, FIG. 3 shows an example 300 of correspondence among terminal devices, users, and applications. The example 300 involves 3 terminal devices 110 (i.e., the terminal device 110-1, the terminal device 110-2, and the terminal device 110-3), 4 users 150 (i.e., the user 150-1, the user 150-2, the user 150-3, and the user 150-4), and 6 applications 112 (i.e., the application 112-1, the application 112-2, the application 112-3, the application 112-4, the application 112-5, and the application 112-6), and the 6 applications may each be associated with a digital assistant. As an example, if the user 150-1 interacts with the digital assistant via the application 112-4 installed on the terminal device 110-2, the application corresponding to the user request of the user 150-1 is the application 112-4, and the corresponding terminal device is the terminal device 110-2. In this case, the user request determined by the terminal device 110-2 may include a device identifier of the terminal device 110-2, an application identifier of the application 112-4, and a user identifier of the user 150-1.

After receiving the user request, the terminal device 110 may send (212) the user request to the server device 120. As an example, the terminal device 110 may, for example, send the user request to the server device 120 through a communication connection between the terminal device 110 and the server device 120. In some embodiments, the dialog service 201 in the server device 120 may receive a user request. The dialog service 201 may determine whether a plug-in is to be acquired for the user request. The dialog service 201 may determine whether to acquire the plug-in in any suitable manner, and the present disclosure does not limit the specific determining manner.

For example, the server device 120 may store a service table. If the user request indicates that the service provided by the digital assistant is a service included in the service table, the dialog service 201 may determine that no plug-in needs to be acquired, and the digital assistant may directly provide the service corresponding to the user request. If the user request indicates that the service provided by the digital assistant is a service other than services included in the service table, the dialog service 201 may determine that a plug-in needs to be acquired to provide the service by means of the plug-in.

In response to determining to acquire the plug-in, the dialog service 201 may extract a plug-in acquiring request from the user request or generate the plug-in acquiring request based on the user request, and the present disclosure does not limit the specific manner of determining the plug-in acquiring request. The plug-in acquiring request may indicate that the plug-in requested for the user is to be acquired. The plug-in acquiring request may include, for example, at least identification information extracted from the user request.

The conversation service 201 may send (213) the plug-in acquiring request to the plug-in service 140. The plug-in service 140 may perform (214) plug-in screening on the plurality of candidate plug-ins based on the status information of the plurality of candidate plug-ins for the digital assistant, to determine, from the plurality of candidate plug-ins, one or more plug-ins in an enabled status for the user request. The plurality of candidate plug-ins may be, for example, all plug-ins that have been created and are associated with the digital assistant, and the plurality of candidate plug-ins may be created and published by one or more users, and the one or more users may include the target user or may not include the target user.

In some embodiments, for each candidate plug-in, its status information may indicate an enabled status or a disabled status of the corresponding candidate plug-in. This enabled status or disabled status may be configured on candidate plug-in by a plug-in maintainer of the candidate plug-in (e.g., the developer of the plug-in). This enabled status or disabled status may be for all users. For example, if the developer of the candidate plug-in A configures the candidate plug-in to be in the disabled status, the candidate plug-in A is disabled for all devices, all users, and all applications.

Alternatively, or additionally, in some embodiments, for each candidate plug-in, its status information may also indicate an enabled status or a disabled status of the corresponding candidate plug-in for the one or more terminal devices, an enabled status or a disabled status for the one or more users, an enabled status or a disabled status for one or more applications associated with the digital assistant. The enabled status and the disabled status of each candidate plug-in for the terminal device, the user, and the application may be configured by the user, or may be configured by a plug-in maintainer, a device maintainer (for example, a device factory), or an application maintainer (for example, a developer of an application). For example, for user A, he/she may disable the candidate plug-in A, in which case, the user request initiated by candidate plug-in A for user A may be in a disabled status.

It may be understood that, if the status information of the candidate plug-in B indicates that the candidate plug-in B is in the disabled status for the terminal device A, the candidate plug-in B is in the disabled status for the user request initiated via the terminal device A (regardless of the user or application that initiated the user request). In this case, for a user request initiated by another terminal device other than the terminal device A, the candidate plug-in B may be, for example, in an enabled status.

If the status information of the candidate plug-in C indicates that the candidate plug-in C is in the disabled status for the user A, the candidate plug-in C is in the disabled status for the user request initiated by the user A (regardless of the terminal device or application corresponding to the user request). In this case, for a user request initiated by other users other than the user A, the candidate plug-in C may be, for example, in an enabled status.

If the status information of the candidate plug-in D indicates that the candidate plug-in D is in a disabled status for the application A, the candidate plug-in D is in the disabled status for the user request initiated via the application A (regardless of the user or the terminal device that initiated the user request). In this case, for a user request initiated by another application other than the application A, the candidate plug-in D may be, for example, in an enabled status.

In some embodiments, the plug-in service 140 may determine the at least one candidate plug-in in the enabled status from the plurality of candidate plug-ins based on the status information of the plurality of candidate plug-ins for the digital assistant. That is, the at least one plug-in includes a plug-in configured to be in an enabled status by a corresponding plug-in maintainer. Further, the plug-in service 140 may determine, from the at least one candidate plug-in based on the status information of the plurality of candidate plug-ins and the identification information, one or more plug-ins in the enabled status for the target user, and/or the target application, and/or the target terminal device.

As an example, the status information of each candidate plug-in may include, for example, one or more device identifiers (device_ids), and/or one or more user identifiers (user_ids), and/or one or more application identifiers (app_ids) for identifying that the candidate plug-in is in a disabled status for one or more identified terminal devices, and/or one or more identified users, and/or one or more identified applications (or in an alternative example, in an enabled status). For example, if the status information of the candidate plug-in E includes the identification information of the terminal device A, it may be determined that the candidate plug-in E is in a disabled status for the terminal device A, and therefore all user requests initiated by the terminal device A are in the disabled status. Similar judgment may also be made based on the identification information for the user request in the user dimension or the application dimension. In this case, the plug-in service 140 may determine whether the identification information of each of the at least one candidate plug-in includes the identification information of the target user by comparing the status information of the candidate plug-in with the identification information carried in the user request.

The user request for the digital assistant may be associated to a certain application in the application dimension, may be associated to a certain user in the user dimension, and may be associated to a device in the device dimension. Assuming that the status information of a certain candidate plug-in includes the device identifier, and/or, the user identifier, and/or the device identifier in the disabled status, if it is detected that the status information of the candidate plug-in includes at least part of the identifier information in the user request (for example, including at least one of the device identifier of the target terminal device, the user identifier of the target user, and the application identifier of the target application corresponding to the user request), the plug-in service 140 may determine that the candidate plug-in is in the disabled status for the user request.

In contrast, if the status information of the candidate plug-in does not include the identification information carried in the user request, the plug-in service 140 may determine that the candidate plug-in is enabled for the user. For example, if the device identifier carried in the user request indicates that the user request is from the terminal device A, the plug-in service 140 may determine that the candidate plug-in E is disabled for the user request.

Alternatively, it is assumed that the status information of a candidate plug-in includes a device identifier, and/or the user identifier, and/or the device identifier in the enabled status, and if the status information of the candidate plug-in includes at least part of the identifier information in the user request, the plug-in service 140 may determine that the candidate plug-in is in the enabled status for the user. The plug-in service 140 may determine, in a similar manner, one or more plug-ins in the enabled status for the user request.

It should be noted that, only one example in which one or more plug-ins in the enabled status for the user request is determined based on the status information of the plurality of candidate plug-ins and the identification information is shown, and the plug-in service 140 may perform plug-in screening in any appropriate manner, and the present disclosure is not limited on the specific manner.

The plug-in service 140 may return 215 the screened plug-in to the dialog service 201 (i.e., send the determined one or more plug-ins to the dialog service 201). In some embodiments, the dialog service 201 may directly determine one or more plug-ins returned by the dialog service as the first set of plug-ins. Alternatively or additionally, in some embodiments, if the one or more plug-ins include a plurality of plug-ins, the dialog service 201 may further compare the number of the plurality of plug-ins to a threshold number, and determine (216) whether the plurality of plug-ins need to be secondarily screened by using the trained machine learning model (e.g., the machine learning model 203) based on the comparison result to determine the first set of plug-ins from the plurality of plug-ins.

The threshold number may be predetermined by the user (for example, the target user), or may be determined by the server device 120 itself, and it may be any appropriate number. Specifically, if the number of the plurality of plug-ins that are in the enabled status for the user request does not exceed the threshold number, the dialog service 201 may determine that there is no need to screen the plurality of plug-ins secondarily by means of the machine learning model 203. The dialog service 201 may directly determine the plurality of plug-ins as the first set of plug-ins. If the number of the plurality of plug-ins that are in the enabled status for the user request exceeds the threshold number, the dialog service 201 may determine that the plurality of plug-ins need to be secondarily screened by means of the machine learning model 203 so as to determine the first set of plug-ins from the plurality of plug-ins.

Regarding a specific manner of secondary screening, in some embodiments, the dialog service 201 may determine model input for the machine learning model 203 based on the description information and the user request respectively corresponding to the plurality of plug-ins in the enabled status. The description information of each plug-in may indicate at least a function of the plug-in. The dialog service 201 may utilize (217) the machine-learning model 203 to secondarily screen the plurality of plug-ins by providing the model input to the machine-learning model 203, so as to determine the first set of plug-ins from the plurality of plug-ins. The machine learning model 203 may generate a corresponding model output based on the received model input, and the model output may indicate the first set of plug-ins. The machine learning model 203 may return 218 the model output to the dialog service 201, i.e., return the first set of plug-ins to the dialog service 201.

The dialog service 201 may use the trained machine learning model to determine at least one target plug-in from the first set of plug-ins based at least on the description information of each plug-in in the first set of plug-ins and the user input. The machine learning model may be the same model as the machine learning model (that is, the machine learning model 203) used to perform secondary screening on the plurality of plug-ins to determine the first set of plug-ins, or they may be different models. For example, the machine learning model used to determine the target plug-in may be the machine learning model 203 or the machine learning model 202. The example description is performed only by taking the machine learning model 202 as an example for determine the target plug-in.

The dialog service 201 may determine, based on based at least on the description information of each plug-in in the first set of plug-ins and the user request, a model input for the machine learning model 202, and the model input is configured to indicate that the target plug-in is acquired from the first set of plug-ins, or the model input may be referred to as a target plug-in request. By providing (219) the model input to the machine learning model 202, the dialog service 201 may utilize the machine learning model 202 to determine at least one target plug-in from the first set of plug-ins. The machine learning model 202 may generate a corresponding model output based on the received model input, and the model output may indicate at least one target plug-in. The machine learning model 202 may return (220) the model output to the dialog service 201, i.e., return at least one target plug-in to the dialog service 201.

The dialog service 201 may then at least partially process the user request by invoking the at least one target plug-in to determine a reply of the digital assistant to the user request. Specifically, the dialog service 201 may send (221) to the plug-in service 140 an invocation request for at least one target plug-in. In some embodiments, if the at least one target plug-in includes a plurality of target plug-ins, and the plurality of target plug-ins have a certain invoking sequence, the invocation request sent by the dialog service 201 may further include the invoking sequence. For example, if the plurality of target plug-ins include a plug-in for playing music and a plug-in for dynamically displaying lyrics, the invoking sequence may indicate that the plug-in for playing music is called first, and then the plug-in for dynamically displaying lyrics is called.

The plug-in service 140 may invoke the at least one target plug-in based on the invocation request to process the user request. It may be understood that, if the operation indicated by the user request includes a plurality of operations, there may be an operation in the plurality of operations that does not need to invoke the plug-in, and in this case, the at least one target plug-in may be only used to handle operations in the plurality of operations that need to be implemented by using the plug-in. Thus, the at least one target plug-in may only be used to handle a part of operations indicated by the user request. That is, the plug-in service 140 may invoke the at least one target plug-in based on the invocation request to at least partially process the user request. The plug-in service 140 may obtain an invocation result for the at least one target plug-in, and return (222) invocation result of the at least one target plug-in to the dialog service 201.

The dialog service 201 may determine a reply of the digital assistant to the user request based on the invocation result of the at least one target plug-in. In some embodiments, if the user request may be completely processed by invoking the at least one target plug-in, the dialog service 201 may directly determine, based on the invocation result for the at least one target plug-in, the reply of the digital assistant to the user request. Alternatively, or additionally, in some embodiments, if the user request may only be partially processed by invoking the at least one target plug-in, the dialog service 201 may determine the reply of the digital assistant to the user request based on at least the invocation result for the at least one target plug-in. For example, if the user request indicates a plurality of operations, the dialog service 201 may determine the reply of the digital assistant to the user request based on the result of the at least one target plug-in processing partial operation (that is, the invocation result of the at least one target plug-in) and a processing result of operations performed without the plug-in.

With respect to the particular manner in which the reply is determined, in some embodiments, the dialog service 201 may determine the reply with the aid of a trained language model (such as the machine learning model 202). Specifically, the dialog service 201 may determine a model input for the machine learning model 202 based on at least the invocation result for the at least one target plug-in and the user request. In some embodiments, the dialog service 201 may also determine model input based on contextual information of the target user. The context information of the target user may include one or more of environment information of the target user, historical interaction information of the target user with the digital assistant, device information/application information of the target terminal device/target application corresponding to the user request, and the like.

This model input is used to indicate that a reply is determined for the user request, and this model input may also be referred to as a reply generation request. The dialog service 201 may utilize the machine learning model 202 to generate a reply to the user request by providing (223) the model input to the machine learning model 202. The machine learning model 202 may generate a corresponding model output based on the received model input, and the model output may indicate a reply to the user request. The machine learning model 202 may return (224) the model output to the dialog service 201, i.e., return to the dialog service 201 a reply to the user request.

The dialog service 201 may send (225) to the terminal device 110 a reply to the user request based on the communication connection between the server device 120 and the terminal device 110. The terminal device 110 may provide (226) the target user with a reply to the user request in response to receiving the reply. It may be understood that the reply may be any suitable form of reply including, but not limited to, a text type, an audio type, a video type, an image type, a document type, and the like. The terminal device 110 may also provide a reply to the target user via an interaction interface of the target user with the digital assistant, and the reply may be presented in the interaction interface in the form of a conversation message from the digital assistant.

Therefore, at least one round of screening may be performed on the plurality of candidate plug-ins before the target plug-in is determined, and the target plug-in is determined from the first set of plug-ins obtained through the screening. The target plug-in for processing the user request can be determined from a small number of screened plug-ins, thus the calculation overhead required for selecting the target plug-in in the request processing can be reduced, and the efficiency and accuracy of determining the plug-in are improved.

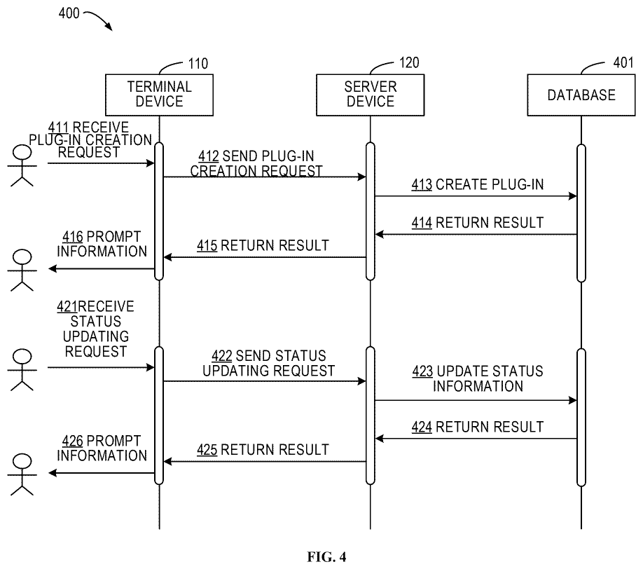

Example embodiments of screening a plurality of candidate plug-ins, determining a target plug-in from a first set of plug-ins obtained through screening, and processing a user request by invoking the target plug-in to determine a reply are described above. In the above example, it is assumed that a plug-in that can be used by the digital assistant can be created, and the enabled status or disabled status can be flexibly configured by various users including the plug-in maintainer or the digital assistant. An example of creation and updating of the plug-in is described below with reference to FIG. 4. FIG. 4 illustrates a flowchart of a signaling flow 400 for creating and updating plug-ins according to some embodiments of the present disclosure. The signaling flow 400 relates to the terminal device 110, the server device 120, and the database 401. The database 401 may be used to store plug-ins that have been created (e.g., for storing a plurality of candidate plug-ins above). The database 401 may be deployed at the plug-in service 140.

The terminal device 110 may, for example, present a plug-in creation page for creating a plug-in, and receive (411) a plug-in creation request from a plug-in maintainer of the plug-in (e.g., a developer of the plugin) via the plug-in creation page. The plug-in creation page may be any suitable page, including but not limited to a programming page, an interaction page between the user and the digital assistant, and the like. The plug-in creation request may indicate at least one of a name, a function, status information, and the like of the plug-in to be created. The terminal device 110 may send (412) a plug-in creation request to the server device 120. The server device 120 or the plug-in service 140 in the server device 120 may create (413) a corresponding plug-in based on the received plug-in creation request, and store plug-in information corresponding to the created plug-in in the database 401.

The database 401 may return (414) to the server device 120 a result indicating that the plug-in was successfully stored and that the plug-in was created successfully. It will be appreciated that this result may also indicate that the plug-in creation fails or the plug-in storage fails. The server device 120 may return (415) the result indicating that creation of the plug-in is successful/failed to the terminal device 110 in response to receiving the result. The terminal device 110 may provide, in response to receiving the result, prompt information indicating that the plug-in is successfully created/the creation of plug-in is failed to the plug-in maintainer. The terminal device 110 may provide the prompt information in any suitable manner such as playing audio, playing a video, presenting text, presenting an image, and vibrating, which is not limited in the present disclosure.

In some embodiments, the terminal device 110 may further receive (421) a status update request for one or more of the plurality of created candidate plug-ins from the plug-in maintainer or from the target user and (that is, the status update request may be for only a part of the candidate plug-ins of all the candidate plug-ins). It may be understood that, the terminal device that receives the status update request from the plug-in maintainer and the terminal device that receives the status update request from the target user may be different terminal devices, and the present disclosure merely uses the terminal device 110 as an example for example description. For example, the terminal device 110 may provide a configuration page for the created plug-in, and receive a status update request for the plug-in via the configuration page. Similarly, this configuration page may also be any suitable page. The status update request may indicate of which plug-in or which plug-ins the status information is to be updated and how the update is to be performed. As an example, the status update request from the plug-in maintainer may indicate that the status information of the candidate plug-in A is switched from the enabled status to the disabled status. Similarly, the status update request from the target user may indicate to switch the status information of the candidate plug-in B from the disabled status to the enabled status for the target user.

The terminal device 110 may send (422) status update request to the server device 120. The server device 120 or the plug-in service 140 in the server device 120 may determine, based on the received status update request, one or more candidate plug-ins to be updated, and determine how to update the one or more candidate plug-ins. The server device 120 or the plug-in service 140 may update (423) the status information of one or more candidate plug-ins in the database 401 based on the determination.

It should be noted that although only one database 401 is shown in FIG. 4, in practice, there may be a plurality of databases, and all of the plurality of databases store a plurality of candidate plug-ins that have been created. As an example, for a target user, two data tables, for example, a first data table and a second data table, may be included. Both the first data table and the second data table may be used to store a plurality of candidate plug-ins. In some embodiments, for the same candidate plug-in, the status information stored in the first data table and corresponding to the candidate plug-in may be for all users, which may only be adjusted based on the status update request from the plug-in maintainer. The status information stored in the second data table and corresponding to the candidate plug-in may be for a specific user (for example, the target user), which may be adjusted only based on the status update request from the target user.

Referring to Table 1 and Table 2, Table 1 shows an example of a certain candidate plug-in in the first data table, and Table 2 shows an example of a certain candidate plug-in in the second data table:

TABLE 1

| Field | Type | Description |
|---|---|---|
| plug-in_tool_id | varchar (128) | Plug-in ID |
| plug-in_tool_name | varchar (128) | Plug-in Name |
| plug-in_tool_desc | varchar (1024) | Description Information |
| | | for Plug-ins |
| status | tinyint | Enabled status/disabled |
| | | status |
| update_time | timestamp | Update time |
| create_time | timestamp | Creation Time |

TABLE 2

| Field | Type | Description |
|---|---|---|
| plug-in_tool_id | varchar(128) | Plug-in ID |
| user_id | bigint | User ID, which may be |
| | | null |
| app_id | varchar (64) | Application ID, which may |
| | | be null |
| device_id | varchar (128) | Device ID, which may be |
| | | null |
| create_time | timestamp | Creation Time |
| update_time | timestamp | Update time |

As shown in Table 1, the first data table may be stored with status information (that is, status) of the candidate plug-in, and the status information indicates that the corresponding candidate plug-in is in an enabled status or a disabled status. This status information is for all users, which may only be adjusted based on status update requests from plug-in maintainer.

As shown in Table 2, in the second data table, if the data table of the candidate plug-in stores one or more of the user ID, the application ID, and the device ID therein, it may be determined that the status information of the candidate plug-in indicates that the corresponding candidate plug-in is in the enabled status or the disabled status for the target user, and/or for the target application, and/or for the target terminal device. The status information may be adjusted based on a status update request from the target user.

After the status information of the one or more candidate plug-ins in the database 401 is updated, a result indicating that the update of the status information is successful or failed may be returned (424) to the server device 120. In response to receiving the result, the server device 120 may return (435), to the terminal device 110, the result indicating that the update of the status information is successful or failed. In response to receiving the result, the terminal device 110 may provide, to the plug-in maintainer/the target user, prompt information indicating that the update of the status information is successful or failed. The terminal device 110 may also provide prompt information in any suitable manner such as playing audio, playing a video, presenting text, presenting an image, and vibrating, which is not limited in the present disclosure.

Therefore, the plug-in maintainer/target user can update the status information of the plug-in by himself/herself, and the flexibility and efficiency of status information updating can be improved.

In summary, according to the embodiments of the present disclosure, at least one round of screening may be performed on the plurality of candidate plug-ins before the target plug-in is determined, and the target plug-in is determined from the first set of plug-ins obtained through screening. The target plug-in for processing the user request can be determined from a small number of screened plug-ins, therefore the calculation cost required for determining the target plug-in can be reduced, and the accuracy and efficiency of determining the target plug-in are improved.

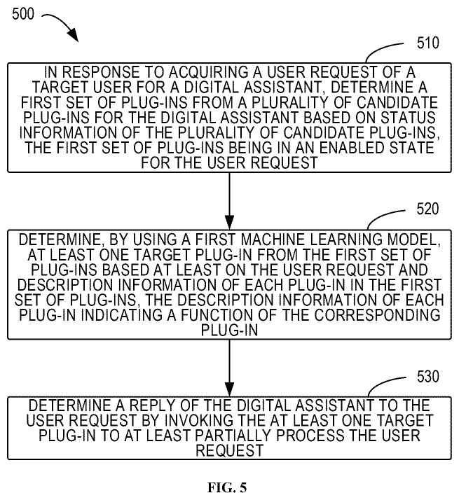

FIG. 5 illustrates a flowchart of a method 500 for request processing according to some embodiments of the present disclosure. The method 500 may be implemented at the server device 120. This will be described with reference to environment 100 of FIG. 1.

At block 510, the server device 120 determines, in response to acquiring a user request of a target user for a digital assistant, a first set of plug-ins from a plurality of candidate plug-ins for the digital assistant based on status information of the plurality of candidate plug-ins, the first set of plug-ins being in an enabled status for the user request.

At block 520, the server device 120 determines, by using a first machine learning model, at least one target plug-in from the first set of plug-ins based at least on the user request and description information of each plug-in in the first set of plug-ins, the description information of each plug-in indicating a function of the corresponding plug-in.

At block 530, the server device 120 determines a reply of the digital assistant to the user request by invoking the at least one target plug-in to at least partially process the user request.

In some embodiments, the status information of each candidate plug-in in the plurality of candidate plug-ins indicates at least one of an enabled status or a disabled status, an enabled status or a disabled status for one or more terminal devices, an enabled status or a disabled status for one or more users, or an enabled status or a disabled status for one or more applications associated with the digital assistant.

In some embodiments, determining the first set of plug-ins from the plurality of candidate plug-ins includes: determining at least one candidate plug-in in an enabled status from the plurality of candidate plug-ins based on the status information of the plurality of candidate plug-ins; extracting identification information from the user request, the identification information comprising at least one of: a device identifier of a target terminal device corresponding to the user request, a user identifier of the target user, or an application identifier of a target application corresponding to the user request; and determining, from the at least one candidate plug-in, the first set of plug-ins in an enabled status for the target user, and/or for the target application, and/or for the target terminal device, based on the status information of the plurality of candidate plug-ins and the identification information.

In some embodiments, the method 500 further includes, in response to receiving a status update request for one or more candidate plug-ins in the plurality of candidate plug-ins, updating the status information of the one or more candidate plug-ins, wherein the status update request is received from a plug-in maintainer of the one or more candidate plug-ins and indicates updating the one or more candidate plug-ins to be in an enabled status or a disabled status, or wherein the status update request is received from the target user and indicates updating the one or more candidate plug-ins to be in an enabled status or a disabled status for a target terminal device, and/or for a target application associated with the digital assistant, and/or for the target user.

In some embodiments, determining the first set of plug-ins from the plurality of candidate plug-ins includes: determining, from the plurality of candidate plug-ins, a plurality of plug-ins in the enabled status for the user request, based on the status information of the plurality of candidate plug-ins; and in response to the number of the plurality of plug-ins in the enabled status exceeding a threshold number, determining the first set of plug-ins from the plurality of plug-ins in the enabled status by using a second machine learning model.

In some embodiments, determining the first set of plug-ins from the plurality of plug-ins in the enabled status includes: determining, by using the second machine learning model, the first set of plug-ins from the plurality of plug-ins in the enabled status based on the description information corresponding to each of the plurality of the plug-ins in the enabled status and the user request.

In some embodiments, a model size of the second machine learning model is smaller than the model size of the first machine learning model.

In some embodiments, determining the first set of plug-ins from the plurality of candidate plug-ins includes: in response to the number of the plurality of plug-ins in the enabled status not exceeding the threshold number, determining the plurality of plug-ins as the first set of plug-ins.

In some embodiments, determining the reply of the digital assistant to the user request by invoking the at least one target plug-in includes: obtaining an invocation result for the at least one target plug-in by invoking the at least one target plug-in to at least partially process the user request; and determining the reply of the digital assistant to the user request based at least on the invocation result and the user request.

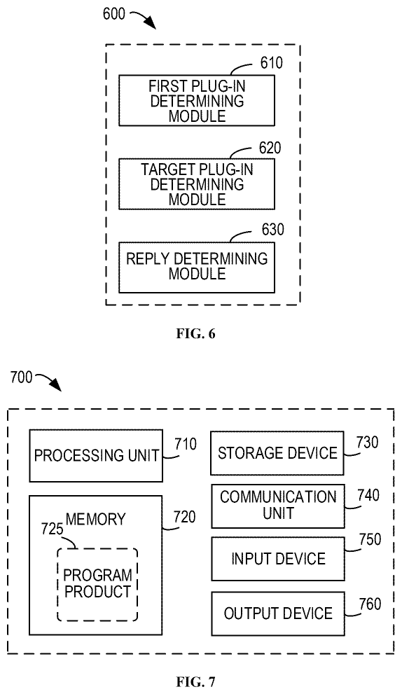

Embodiments of the present disclosure also provide a corresponding apparatus for implementing the above method or process. FIG. 6 illustrates an example structural block diagram of an apparatus 600 for request processing according to some embodiments of the present disclosure. The apparatus 600 may be implemented or included in the server device 120. The various modules/components in the apparatus 600 may be implemented by hardware, software, firmware, or any combination thereof.

As shown in FIG. 6, the apparatus 600 includes a first plug-in determining module 610 configured to determine, in response to acquiring a user request of a target user for a digital assistant, a first set of plug-ins from a plurality of candidate plug-ins for the digital assistant based on status information of the plurality of candidate plug-ins, the first set of plug-ins being in an enabled status for the user request. The apparatus 600 further includes a target plug-in determining module 620 configured to determine, by using a first machine learning model, at least one target plug-in from the first set of plug-ins based at least on description information of each plug-in in the first set of plug-ins and the user request, the description information of each plug-in indicating a function of the corresponding plug-in. The apparatus 600 further includes a reply determining module 630 configured to determine a reply of the digital assistant to the user request by invoking the at least one target plug-in to at least partially process the user request.

In some embodiments, the status information of each candidate plug-in in the plurality of candidate plug-ins indicates at least one of an enabled status or a disabled status, an enabled status or a disabled status for one or more terminal devices, an enabled status or a disabled status for one or more users, or an enabled status or a disabled status for one or more applications associated with the digital assistant.

In some embodiments, the first plug-in determining module 610 is further configured to: determine at least one candidate plug-in in an enabled status from the plurality of candidate plug-ins based on the status information of the plurality of candidate plug-ins; extract identification information from the user request, the identification information comprising at least one of: a device identifier of a target terminal device corresponding to the user request, a user identifier of the target user, or an application identifier of a target application corresponding to the user request; and determine, from the at least one candidate plug-in, the first set of plug-ins in an enabled status for the target user, and/or for the target application, and/or for the target terminal device, based on the status information of the plurality of candidate plug-ins and the identification information.

In some embodiments, the apparatus 600 further includes an information updating module configured to update, in response to receiving a status update request for one or more candidate plug-ins in the plurality of candidate plug-ins, the status information of the one or more candidate plug-ins, where the status update request is received from a plug-in maintainer of the one or more candidate plug-ins to indicate that the one or more candidate plug-ins are updated to be in an enabled status or a disabled status, or where the status update request is received from the target user to indicate that the one or more candidate plug-ins are updated to be in an enabled status or a disabled status for a target terminal device, and/or for a target application associated with the digital assistant, and/or for the target user.

In some embodiments, the first plug-in determining module 610 is further configured to determine, determining, from the plurality of candidate plug-ins, a plurality of plug-ins in the enabled status for the user request, based on the status information of the plurality of candidate plug-ins; and in response to the number of the plurality of plug-ins in the enabled status exceeding a threshold number, determine the first set of plug-ins from the plurality of plug-ins in the enabled status by using a second machine learning model.

In some embodiments, the first plug-in determining module 610 is further configured to determine, by using the second machine learning model, the first set of plug-ins from the plurality of plug-ins in the enabled status based on the description information corresponding to each of the plug-ins in the enabled status and the user request.

In some embodiments, a model size of the second machine learning model is smaller than a model size of the first machine learning model.

In some embodiments, the first plug-in determining module 610 is further configured to determine, in response to the number of the plurality of plug-ins in the enabled status not exceeding the threshold number, the plurality of plug-ins as the first set of plug-ins.

In some embodiments, the reply determining module 630 is further configured to: obtain an invocation result for the at least one target plug-in by invoking the at least one target plug-in to at least partially process the user request; and determine the reply of the digital assistant to the user request based at least on the invocation result and the user request.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-chip (SOCs), complex programmable logic devices (CPLDs), and the like.

It should be understood that one or more of the above methods may be performed by a suitable electronic device or a combination of electronic devices. Such an electronic device or a combination of electronic devices may include, for example, the server device 120 in FIG. 1.

FIG. 7 illustrates a block diagram of an electronic device 700 in which one or more embodiments of the present disclosure may be implemented. It should be understood that the electronic device 700 shown in FIG. 7 is merely exemplary and should not constitute any limitation on the functions and scope of the embodiments described in this specification. The electronic device 700 shown in FIG. 7 may be configured to implement the server device 120 or the terminal device 110 of FIG. 1, or the apparatus 600 of FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units execute computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data and that can be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for request processing, comprising:
in response to acquiring a user request of a target user for a digital assistant, determining a first set of plug-ins from a plurality of candidate plug-ins for the digital assistant based on status information of the plurality of candidate plug-ins, the first set of plug-ins being in an enabled status for the user request;
determining, by using a first machine learning model, at least one target plug-in from the first set of plug-ins based at least on the user request and description information of each plug-in in the first set of plug-ins, the description information of each plug-in indicating a function of the corresponding plug-in; and
determining a reply of the digital assistant to the user request by invoking the at least one target plug-in to at least partially process the user request.

2. The method of claim 1, wherein the status information of each candidate plug-in in the plurality of candidate plug-ins indicates at least one of:
an enabled status or a disabled status,
an enabled status or a disabled status for one or more terminal devices,
an enabled status or a disabled status for one or more users, or
an enabled status or a disabled status for one or more applications associated with the digital assistant.

3. The method of claim 2, wherein determining the first set of plug-ins from the plurality of candidate plug-ins comprises:
determining at least one candidate plug-in in an enabled status from the plurality of candidate plug-ins based on the status information of the plurality of candidate plug-ins;
extracting identification information from the user request, the identification information comprising at least one of: a device identifier of a target terminal device corresponding to the user request, a user identifier of the target user, or an application identifier of a target application corresponding to the user request; and
determining, from the at least one candidate plug-in, the first set of plug-ins in an enabled status for the at least one of target user, the target application, or the target terminal device, based on the status information of the plurality of candidate plug-ins and the identification information.

4. The method of claim 1, further comprising:
in response to receiving a status update request for one or more candidate plug-ins in the plurality of candidate plug-ins, updating the status information of the one or more candidate plug-ins,
wherein the status update request is received from a plug-in maintainer of the one or more candidate plug-ins and indicates updating the one or more candidate plug-ins to be in an enabled status or a disabled status, or
wherein the status update request is received from the target user and indicates updating the one or more candidate plug-ins to be in an enabled status or a disabled status for at least one of a target terminal device, a target application associated with the digital assistant, or the target user.

5. The method of claim 1, wherein determining the first set of plug-ins from the plurality of candidate plug-ins comprises:
determining, from the plurality of candidate plug-ins, a plurality of plug-ins in the enabled status for the user request, based on the status information of the plurality of candidate plug-ins; and
in response to a number of the plurality of plug-ins in the enabled status exceeding a threshold number, determining the first set of plug-ins from the plurality of plug-ins in the enabled status by using a second machine learning model.

6. The method of claim 5, wherein determining the first set of plug-ins from the plurality of plug-ins in the enabled status comprises:
determining, by using the second machine learning model, the first set of plug-ins from the plurality of plug-ins in the enabled status based on the user request and the description information corresponding to each of the plurality of the plug-ins in the enabled status.

7. The method of claim 5, wherein a model size of the second machine learning model is smaller than a model size of the first machine learning model.

8. The method of claim 5, wherein determining the first set of plug-ins from the plurality of candidate plug-ins comprises:
in response to the number of the plurality of plug-ins in the enabled status not exceeding the threshold number, determining the plurality of plug-ins as the first set of plug-ins.

9. The method of claim 1, wherein determining the reply of the digital assistant to the user request by invoking the at least one target plug-in comprises:
obtaining an invocation result for the at least one target plug-in by invoking the at least one target plug-in to at least partially process the user request; and
determining the reply of the digital assistant to the user request based at least on the invocation result and the user request.

10. An electronic device, comprising:
at least one processor; and
at least one memory coupled to the at least one processor and storing instructions for execution by the at least one processor, the instructions, when executed by the at least one processor, causing the electronic device to perform operations comprising:
in response to acquiring a user request of a target user for a digital assistant, determining a first set of plug-ins from a plurality of candidate plug-ins for the digital assistant based on status information of the plurality of candidate plug-ins, the first set of plug-ins being in an enabled status for the user request;
determining, by using a first machine learning model, at least one target plug-in from the first set of plug-ins based at least on the user request and description information of each plug-in in the first set of plug-ins, the description information of each plug-in indicating a function of the corresponding plug-in; and
determining a reply of the digital assistant to the user request by invoking the at least one target plug-in to at least partially process the user request.

11. The device of claim 10, wherein the status information of each candidate plug-in in the plurality of candidate plug-ins indicates at least one of:
an enabled status or a disabled status,
an enabled status or a disabled status for one or more terminal devices,
an enabled status or a disabled status for one or more users, or
an enabled status or a disabled status for one or more applications associated with the digital assistant.

12. The device of claim 11, wherein determining the first set of plug-ins from the plurality of candidate plug-ins comprises:
determining at least one candidate plug-in in an enabled status from the plurality of candidate plug-ins based on the status information of the plurality of candidate plug-ins;
extracting identification information from the user request, the identification information comprising at least one of: a device identifier of a target terminal device corresponding to the user request, a user identifier of the target user, or an application identifier of a target application corresponding to the user request; and
determining, from the at least one candidate plug-in, the first set of plug-ins in an enabled status for at least one of the target user, the target application, or the target terminal device, based on the status information of the plurality of candidate plug-ins and the identification information.

13. The device of claim 10, the operations further comprising:
in response to receiving a status update request for one or more candidate plug-ins in the plurality of candidate plug-ins, updating the status information of the one or more candidate plug-ins,
wherein the status update request is received from a plug-in maintainer of the one or more candidate plug-ins and indicates updating the one or more candidate plug-ins to be in an enabled status or a disabled status, or
wherein the status update request is received from the target user and indicates updating the one or more candidate plug-ins to be in an enabled status or a disabled status for at least one of a target terminal device, a target application associated with the digital assistant, or the target user.

14. The device of claim 10, wherein determining the first set of plug-ins from the plurality of candidate plug-ins comprises:
determining, from the plurality of candidate plug-ins, a plurality of plug-ins in the enabled status for the user request, based on the status information of the plurality of candidate plug-ins; and
in response to a number of the plurality of plug-ins in the enabled status exceeding a threshold number, determining the first set of plug-ins from the plurality of plug-ins in the enabled status by using a second machine learning model.

15. The device of claim 14, wherein determining the first set of plug-ins from the plurality of plug-ins in the enabled status comprises:
determining, by using the second machine learning model, the first set of plug-ins from the plurality of plug-ins in the enabled status based on the user request and the description information corresponding to each of the plurality of the plug-ins in the enabled status.

16. The device of claim 14, wherein a model size of the second machine learning model is smaller than a model size of the first machine learning model.

17. The device of claim 14, wherein determining the first set of plug-ins from the plurality of candidate plug-ins comprises:
in response to the number of the plurality of plug-ins in the enabled status not exceeding the threshold number, determining the plurality of plug-ins as the first set of plug-ins.

18. The device of claim 10, wherein determining the reply of the digital assistant to the user request by invoking the at least one target plug-in comprises:
obtaining an invocation result for the at least one target plug-in by invoking the at least one target plug-in to at least partially process the user request; and
determining the reply of the digital assistant to the user request based at least on the invocation result and the user request.

19. A non-transitory computer-readable storage medium having stored thereon a computer program, the computer program being executable by a processor to implement a method comprising:
in response to acquiring a user request of a target user for a digital assistant, determining a first set of plug-ins from a plurality of candidate plug-ins for the digital assistant based on status information of the plurality of candidate plug-ins, the first set of plug-ins being in an enabled status for the user request;
determining, by using a first machine learning model, at least one target plug-in from the first set of plug-ins based at least on the user request and description information of each plug-in in the first set of plug-ins, the description information of each plug-in indicating a function of the corresponding plug-in; and
determining a reply of the digital assistant to the user request by invoking the at least one target plug-in to at least partially process the user request.

20. The storage medium of claim 19, wherein the status information of each candidate plug-in in the plurality of candidate plug-ins indicates at least one of:
an enabled status or a disabled status,
an enabled status or a disabled status for one or more terminal devices,
an enabled status or a disabled status for one or more users, or
an enabled status or a disabled status for one or more applications associated with the digital assistant.
